(19) United States
(12) Patent Application Publication
(10) Pub. No.: US 2005/0003083 A1
(43) Pub. Date: Jan. 6, 2005

(54) Method for producing sized paper or cardboard

(76) Inventors: Juha Lipponen, Kerava (FI); Johan Gron, Espoo (FI)

Correspondence Address: Michael C Stuart;Cohen Pontani Lieberman & Pavane, 551 Fifth Avenue, Suite 1210, New York, NY, 10176, US

(21) Appl. No.: 10/482,504

(22) PCT Filed: Jul. 1, 2002
(86) PCT No.: PCT/FI02/00591

(30) Foreign Application Priority Data
Jul. 3, 2001 (FI) 20011455

(51) Int. Cl. B05D 5/00; B05D 3/12

(52) U.S. Cl. 427/209; 427/355

(57) ABSTRACT

A method is disclosed for manufacturing a surface sized web of paper or paperboard, the method comprising the step of applying to at least one side of the web an aqueous furnish of size. According to the method, the solids content of the size furnish being applied is at least 15% and the size frunish is applied to one side of the web by an amount not greater than 5 g/m² as aqueous furnish of size applied to the web.

The invention relates to a method according to the preamble of claim 1 for manufacturing sized paper or paperboard. In this kind of product, the goal is to improve the web strength by surface sizing the web. Generally, a major portion of the size is starch, and sizing can substantially improve such qualities as the surface strength of the sized web, reduce its dusting propensity and increase its flexural stiffness.

Sizing in the treatment of fine paper grades, the liner web of corrugated board and fluting forms an important step in the manufacture of these products substantially controlling the strength properties of the finished product. Generally, size has been applied to the web surfaces and, with the increasing interest to the manufacture of multilayer products, also to the middle layers of the product in the core thereof. In fine printing papers, the function of size is to improve the printing qualities of the paper web surface by virtue of giving the product a higher surface strength for better durability under the stresses of a printing process and reduced dusting propensity when used in a copier machine, for instance. Different kinds of starch are generally used as size, complemented with a variety of additives. However, since the present invention is not limited to any particular size composition, size must be understood in this context to refer to all compositions that are at least partially absorbable in the base web to be treated and serve to improve the strength of the base web.

Surface sizing in a broad sense means a treatment serving to improve the strength of paper and paperboard webs. The web treatment agent is conventionally starch slurried into an aqueous furnish that obtains its adhesive qualities through a cooking process. To some extent, the art also uses special grades of starch needing no cooking as well as a variety of latex sizes. The function of size is to penetrate into the surface being treated so as to bond the fibers of the web surface into a stronger matrix. However, the surface of the web being treated may not become tacky, and surface sizing is not intended to be used for adhesively bonding the layers of stratified webs to each other. The most important use of surface sizing in paper grades is to improve the quality of print since size prevents capillary spreading of the ink on the paper sheet and to reduce the Tinting propensity of the sheet. Additionally, the strength properties of the paper web are improved. In paperboard grades, the most important object of surface sizing is to improve web strength. Therefore, it is customary to use a maximally large amount of size in high-strength paperboard grades to maximize their strength properties.

However, it is not an object of surface sizing to make a distinct layer on the surface to be treated, but rather, the size should penetrate into the base web and bond the surface layer fibers into a homogeneous layer. Therefore, the solids content of size furnishes is generally kept low. Another factor limiting the use of size furnishes of a higher solids content is presented by the difficult handling of starch sizes and their poor flowability if the solids content is increased. As is evident, surface sizing is an art different from coating and other treatments intended to form a distinct layer on the web surface. As surface sizing is not related to the use of coat pigments, the application of furnishes containing pigments must be referred to the art of coating or combination treatments.

Conventionally, size is applied to the web as an aqueous furnish of a very low solids content. A major complication in the efficiency improvement of machines used for making fine papers and paperboard appears to be the limited drainage capacity of water transported into the web along with the size furnish. In fact, the drying of the fiber furnish used to make a paper or paperboard product in the production line constitutes a substantial portion in the overall energy budget of a paper mill. Since only a limited amount of water can be removed from a moving web by a single dryer, the number of successive dryer units must be increased in proportion to the elevated web speed. The larger number of drying equipment, such as dryer cylinders for instance, drastically increases the length of the papermaking machine and, in particular, its price, whereby the acquisition of a new high-speed line for making paperboard or fine paper grades may rise so high that an investment decision becomes futile. On the other hand, the web speed of existing machinery is limited by the available drying capacity that curtails the maximum running speed and, hence, the potential production capacity.

It is an object of the present invention to provide a method capable of reducing the drying capacity required in the manufacture of sized paper or paperboard thus offering the possibility of lowering the investment costs and at the same time reducing the length of the papermaking line.

The goal of the invention is achieved by way of using high-solids size furnish and/or applying the size in small amounts, however, in such a fashion that gives good strength properties to the end product.

More specifically, the method according to the invention is characterized by what is stated in the characterizing part of claim 1.

The invention offers significant benefits.

The invention makes it possible to significantly reduce the length of new machinery constructions used for making paper and paperboard. Such reduction in the machine length and number of machine components gives substantial savings in the investment costs. By virtue of performing sizing using size furnishes having a solids content higher than those used in conventional size furnishes, the amount of water imported to the web after the press section is smaller and, hence, the need for postdrying is substantially reduced as compared with size application methods wherein sizing takes place only downstream of the press section. As the need for postdrying capacity per produced unit is reduced, also the competitiveness of the end products on the market is increased.

Size may be applied using a film-transfer press or, alternatively, by direct application to the web surface and additionally, if necessary, ensuring sufficient penetration of size into the web with the help of a roll, an extended-nip press roll or a belt press. This kind of arrangement is substantially less complicated than a full-size film transfer press. On the other hand, film-transfer presses have long been used in the art and, hence, they offer field-proven functionality and good controllability under different running conditions. Moreover, a film-transfer press allows both sides of the web to be treated simultaneously, which means that in two-sided sizing the cost of a film-transfer press is approximately equal to the overall cost of combining two size applicators with a press nip. As the equipment required for the implementation of the present invention are simple and occupy a small footprint when adapted in existing machinery, a novel approach is provided for improving the production capacity of operational machinery at a minimal investment cost. Since the wetting of the web is lesser, also the runnability of the paper or paperboard machine is improved by the greater strength of the web.

The present invention may be used in one-sided or two-sided sizing of the web at a point downstream of the dryer. Most advantageously, however, the present method is used in combination with such sizing techniques wherein a portion of the overall amount of size is applied to the web by adding size furnish to the stock, e.g., in a headbox and/or as surface size applied to a wet web on the press section.

In the following, the invention will be examined in more detail with the help of exemplary embodiments.

Conventionally, surface sizing of paper and paperboard is carried out using size furnishes of very low solids content and very large amounts of the furnish are applied to the web. The solids content of the furnishes is generally substantially less than 10%, and the applied amount of size in film-transfer application is 10 to 20 g/m² while in pond application it may be as high as 80 g/m². Since a major portion of this volume is water, surface sizing may invoke a need for a high dryer capacity. According to the present invention, the size furnish applied to the web has a solids content of at least 15 A, advantageously 15 to 40%. Even a higher solids content could be contemplated with the constraint that the size preparation equipment currently used in the art are not necessarily suited for making such high solids furnishes and, further not all applicator apparatuses can be adapted to handle such furnishes.

If the solids content of size applied to the web surface is desired to stay close to a given value, the amount of applied size furnish, that is, the film thickness transferred by a film-transfer applicator, must be reduced. Advantageously, the amount of size applied to the web should not be greater than 5 g/m², whereby also the amount of extra water imported to the web by the size is only a few grams per square meter. Such a small amount of water can be readily removed from the web. As known, a film-transfer applicator can be employed for applying very thin layers. Hence, this apparatus is most appropriate for implementing the present invention. As it may happen that the higher solids of the size furnish decreases size penetration into the web, the nip pressure of a film-transfer applicator can be utilized to ensure a sufficiently deep size penetration into the web. The nip pressure may be adjusted as necessary.

In lieu of a film-transfer press, some other application method and sizing technique may be used, whereby sizing is followed by pressing in a roll-nip press, extended-nip press or belt press. Herein, the applicator apparatuses particularly suited for use in the invention are spray and MIKROJET applicators, both of them being capable of applying smooth and low-weight layers. The construction of a MIKROJET applicator is described in patent publication WO 01/02098 and it comprises a plate with a great number of small holes through which the agent to be applied is delivered. This apparatus performs uniform application in the cross-machine direction and may also be used for controlled application of very small amounts of size or other web treatment agent. As the support element of the apparatus to be mounted in the immediate vicinity of the web is a beam having only a small cross section, the MIKROJET applicator may readily be adapted in a desired position on the papermaking machine. One further technique of controlling size penetration into the web is to adjust the machine-direction distance of the applicator apparatus from the press nip.

As the present invention avails of sizing with very small amounts of applied furnish, it is extremely crucial that no variations in the applied amount are allowed. In a film-transfer applicator, the size profile and amount of applied size are controlled by a doctor element that smoothes and meters the film formed on the surface of the transfer roll. The metered amount of size is controlled based on the loading of the doctor element, while the cross-machine profile is set by means of loading screws acting on the doctor element. To implement such a control system, information is required on the actual amount of size adhering to the web. Since the size furnish with its water content is absorbed by the web, the size weight cannot be directly detected using, e.g., conventional coat weight gauging equipment. However, the size profile may be gauged by measuring the moisture content of the web. To this end, the moisture content of the web must be gauged prior to the size application and thereafter, whereby the amount of added water can be inferred from the difference of these gauging results, while the size solids adhering to the web can be computed from the solids content of the size furnish. An alternative technique of gauging the amount of applied size is to subject the applicator roll to infrared radiation simultaneously detecting the attenuation of the radiation in the size film metered onto the roll surface. With the help of these measurement results it is possible to control the loading of the doctor bar or blade. Obviously, the profile control system must be adapted to be compatible with the applicator apparatus used if some other type of applicator is used in lieu of a filmtransfer press. However, the measurement and control arrangements employed are similar to those described above. The same measurement results may be used for both cross-machine and machine direction profile control, whereby an integrated size weight control is attained.

Maximum benefit from the use of a high-solids size furnish and, hence, a reduced amount of applied size, is achieved when the size is applied to a dry web, which means that in a paper or paperboard machine, surface sizing is adapted to take place downstream of the dryer section. Then, postdrying after sizing needs only minimal drying capacity and the postdryer unit can be made short and implemented at a low cost.

1. A method for manufacturing a surface sized web of paper or paperboard, comprising.
applying to at least one side of the web an aqueous furnish of size wherein the solids content of the aqueous size furnish is at least 15% and the size furnish is applied to one side of the web by an amount not greater than 5 g/m² as aqueous furnish of size applied to the web; and
pressing the applied size furnish into the surface of the web.

2. The method of claim 1, wherein the solids content of the size furnish is 15% to 40%.

3. The method of claim 1, wherein the size furnish is applied to at least one side of the web by means of a film-transfer press.

4. The method of claim 3, wherein the size furnish is applied simultaneously to both sides of the web by means of a film-transfer press, whereby the overall amount of size furnish applied to the web is 10 g/m².

5. The method of claim 1, wherein the size furnish is applied to the web by means of a spray or jet applicator.

6. The method of claim 5, wherein the web is pressed in a nip downstream of the application of size in order to ensure size penetration.

7. The method of claim 6, wherein size penetration into the web is controlled by adjusting the machine-direction distance between application of the size and the press nip.

8. The method of claim 1, wherein the weight profile of size furnish adhered to the web is gauged at least in the cross-machine direction of the web and application of size is adjusted based on the gauging result.

9. The method of claim 1, wherein the size furnish being applied contains cooked starch.

10. The method of claim 2, wherein the size furnish is applied to at least one side of the web by means of a film-transfer press.

11. The method of claim 10, wherein the size furnish is applied simultaneously to both sides of the web by means of a film-transfer press, whereby the overall amount of size furnish applied to the web is 10 g/m².

12. The method of claim 2, wherein the size furnish is applied to the web by means of a spray or jet applicator.

13. The method of claim 12, wherein the web is pressed in a nip downstream of the application of size in order to ensure size penetration.

14. The method of claim 13, wherein size penetration into the web is controlled by adjusting the machine-direction distance between application of the size and the press nip.

15. The method of claim 2, wherein the weight profile of size furnish adhered to the web is gauged at least in the cross-machine direction of the web and application of size is adjusted based on the gauging result.

16. The method of claim 4, wherein the weight profile of size furnish adhered to the web is gauged at least in the cross-machine direction of the web and application of size is adjusted based on the gauging result.

17. The method of claim 2, wherein the size furnish being applied contains cooked starch.

18. The method of claim 4, wherein the size furnish being applied contains cooked starch.
